(19) United States
(12) Patent Application Publication
(10) Pub. No.: US 2006/0284587 A1
(43) Pub. Date: Dec. 21, 2006

(54) Vehicle control system

(75) Inventors: Kentaro Teshima, Kariya-city (JP); Takayuki Yamanaka, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/448,735

(22) Filed: Jun. 8, 2006

(30) Foreign Application Priority Data
Jun. 15, 2005 (JP) 2005-175738

(51) Int. Cl. G05B 19/10

(52) U.S. Cl. 318/567

(57) ABSTRACT

A vehicle control system is disclosed that includes a door opening detecting device for identifying a door of the vehicle to be opened. The vehicle control system also includes a position changing device for changing the position of at least one seat based upon the identification of the door to be opened.

### CROSS REFERENCE TO RELATED APPLICATION

This application is based upon and claims the benefit of priority of Japanese Patent Application No. 2005-175738 filed on Jun. 15, 2005, the content of which is incorporated herein by reference.

### FIELD OF THE INVENTION

The present invention relates to a vehicle control system for automatically changing a position of a vehicle seat.

### BACKGROUND OF THE INVENTION

Various systems have been proposed for automatically opening vehicle doors. For instance, Japanese Abstract Publication No. 10-211819 discloses a system that automatically opens slide doors on either both sides of the vehicle. The system includes a remote control with a switch, and the doors are opened when the switch is operated. However, this system may be inconvenient in certain situations. For instance, when the user is holding baggage, etc. with both hands, it may be inconvenient to operate the switch of the remote control.

In partial response to this problem, Japanese Abstract Publication No. 2004-316231 discloses a smart key entry system with a transmitter that automatically transmits a radio wave with a superposed ID code signal at a predetermined time interval. The system also includes a signal receiving device for receiving the radio wave from the transmitter, and the system further includes a controller. The controller automatically opens the slide door when the signal receiving device receives the radio wave. Thus, the slide doors can be more conveniently opened for the user.

Although the automatic door openers of the prior art can be convenient for the user, the vehicle seats may inhibit the movement of the user within the vehicle. For example, if a person wishes to move into the vehicle and into a third row seat, the person will likely have to move the second row seat forward in order to access the third row seat, which may be inconvenient. Further, if space in front of a vehicle seat is narrow, it may be difficult for a person to move into the seat and/or bypass the seat.

### SUMMARY OF THE INVENTION

A vehicle control system is disclosed that includes a door opening detecting device for identifying a door of the vehicle to be opened. The vehicle control system also includes a position changing device for changing the position of at least one seat based upon the identification of the door to be opened.

A vehicle control system is also disclosed which includes a portable device and a vehicle unit. The vehicle unit includes a plurality of transmitters for transmitting a request signal, and the portable device is able to transmit a response signal that includes an ID code in response to the request signal. The vehicle unit also includes a receiver for receiving the response signal. Furthermore, the vehicle unit includes a controller that collates the ID code and a predetermined registration code to thereby generate a collating result. The collating result is OK when the ID code conforms to the predetermined registration code. The vehicle unit additionally includes a door opening detection device for identifying a door of the vehicle to be opened when the collating result is OK. Also, the vehicle unit includes a position changing device for changing the position of at least one seat based upon the identification of the door to be opened.

### BRIEF DESCRIPTION OF THE DRAWINGS

FIG. 1 is a schematic view of a vehicle control system of a first embodiment;

FIG. 2 is a schematic view of a seat position controller and a steering position controller for the vehicle control system of FIG. 1;

FIG. 3 is a flow chart showing a control method for the vehicle control system of FIG. 1;

FIGS. 4A and 4B are schematic views showing movement of the seats and steering wheel by the vehicle control system of FIG. 1;

FIG. 5 is a flow chart showing a control method for a second embodiment of the vehicle control system;

FIG. 6 is a flow chart showing a control method for a third embodiment of the vehicle control system;

FIG. 7 is a flow chart showing modified control method for the third embodiment of the vehicle control system;

FIG. 8 is a flow chart showing a control method for a fourth embodiment of the vehicle control system;

FIG. 9 is a flow chart showing control method for a fifth embodiment of the vehicle control system;

FIG. 10 is a flow chart showing a portion of method of the fifth embodiment in more detail; and

FIG. 11 is a schematic view showing movement of the seats using the fifth embodiment of the vehicle control system.

### DETAILED DESCRIPTION OF EMBODIMENTS

### First Embodiment

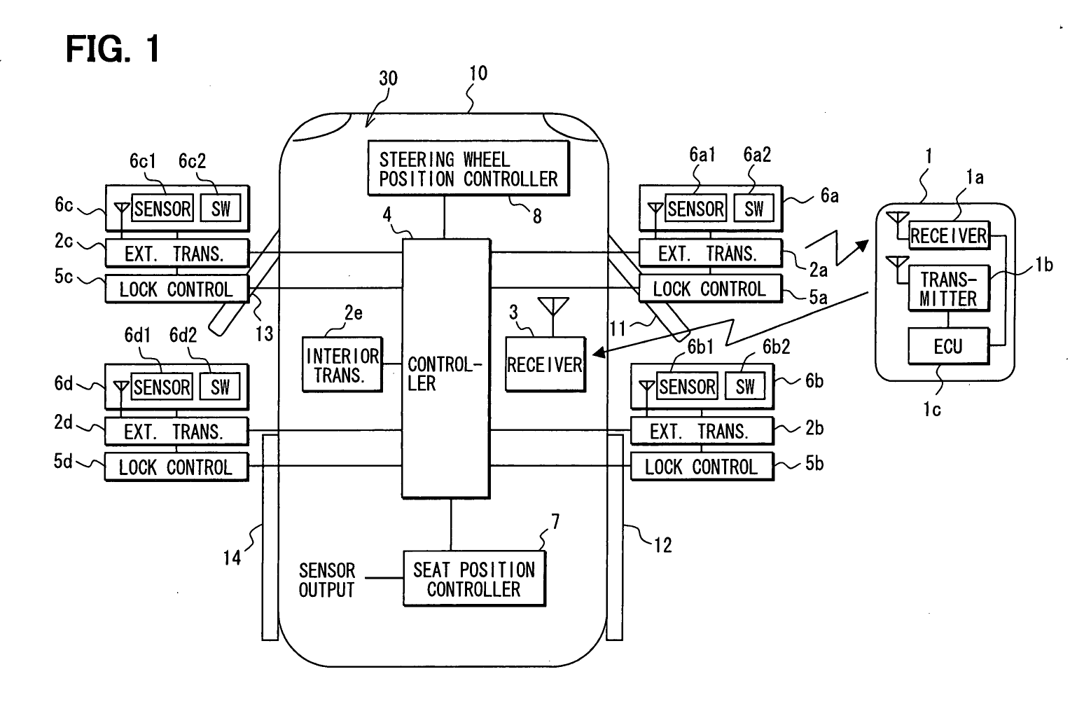

Referring initially to FIG. 1, one embodiment of a vehicle control system for a vehicle 10 is illustrated. The vehicle control system in this embodiment controls lock and unlock states of each vehicle door on the basis of a collating result of an ID code using mutual communication between a portable device 1 (i.e., an electronic key) and a vehicle unit 30. The vehicle unit 30 controls a vehicle seat position and a steering wheel position for the convenience of the user.

In the embodiment shown, the vehicle 10 includes three rows of seats. The vehicle 10 also includes a front passenger side door 13 and a front driver side door 11, both of which are pivotally mounted to the vehicle 10 and are provided for accessing the front row of seats. The vehicle 10 also includes a passenger side sliding door 14, and a driver side sliding door 12 door, both of which are slidably mounted to the vehicle 10 and are provided for accessing the second and third row of seats. It will be appreciated, however, that the vehicle 10 could include any suitable configuration of seats and vehicle doors without departing from the scope of the present invention.

As shown in FIG. 1, vehicle unit 30 includes a plurality of exterior transmitters 2a-2d disposed in respective doors 11-14 and an interior transmitter 2e disposed within the passenger compartment of the vehicle 10. The vehicle unit 30 also includes a controller 4. The transmitters 2a-2e transmit a request signal on the basis of a transmission instruction signal from a controller 4 of the vehicle unit 30.

The portable device 1 has a receiver 1a for receiving a request signal from the transmitters 2a-2e. The portable device 1 also has a transmitter 1b for transmitting a response signal including an ID code, etc. in response to the request signal. An ECU 1c of the portable device 1 is in communication with the receiver 1a and the transmitter 1b, and the ECU 1c executes various kinds of control processes. More specifically, the ECU 1c determines whether any request signal has been received by the receiver 1a, and the ECU 1c generates the response signal to be transmitted by the transmitter 1b.

In one embodiment, the transmitters 2a-2d are able to wirelessly communicate with the portable unit 1 at a respective distance of approximately 0.7 to 1.0 m (i.e., the “arrival distance”). Thus, when the vehicle 10 is parked and the doors 11-14 are locked, and a user with the portable unit 1 is within the arrival distance of one or more of the transmitters 2a-2d, it is detected that the user is approaching the vehicle 10. Further, the interior transmitter 2e is able to communicate with the portable unit 1 when the portable unit 1 is within the passenger compartment of the vehicle 10. Thus, the interior transmitter 2e is used to detect whether or not the portable device 1 is located within the passenger compartment. The vehicle unit 30 may also include a plurality of interior transmitters 2e to thereby provide communication within the passenger compartment of the vehicle 10.

Further, the vehicle unit 30 has a receiver 3 arranged within the passenger compartment of the vehicle 10. The receiver 3 is set to a response signal receivable state in synchronization with the output of the transmission instruction signals of the transmitters 2a-2e. The receiver 3 also receives the response signal transmitted from the portable device 1. The response signal received by the receiver 3 is outputted to the controller 4. The controller 4 collates whether the ID code included in this received response signal satisfies a predetermined relation, such as whether this ID code conforms to a predetermined registration code, etc. In accordance with its collating result, the controller 4 controls the lock and unlock states of the doors 11 to 14, and the controller 4 also controls the seat position and the steering wheel position for the convenience of the vehicle passengers.

The vehicle unit 30 also includes lock control devices 5a-5d arranged in the respective doors 11-14 of the vehicle 10. The lock control devices 5a-5d control the locking and unlocking of the doors 11-14 (i.e., the lock state and the unlock state of the doors). In one embodiment, the lock control devices 5a-5d have a door lock motor, and (according to a lock/unlock signal transmitted from the controller 4) the doors 11-14 are locked or unlocked by rotating the door lock motor.

Furthermore, touch sensors 6a1-6d1 are operatively mounted to respective door handles 6a-6d of the respective vehicle doors 11-14. The touch sensors 6a1-6d1 enable detection of a condition in which the holder of the portable device 1 grips the door handles 6a-6d. In such a case, one or more of the doors 11-14 is unlocked. Further, door lock switches 6a2-6d2 are also disposed in the door handles 6a-6d. In one embodiment, the switches 6a2-6d2 are push switches. When the door lock switches 6a2-6d2 are operated, the respective doors 11-14 return to a locked state. Also, in one embodiment, the door handles 6a-6d operate as antennas for the associated exterior transmitters 2a-2d.

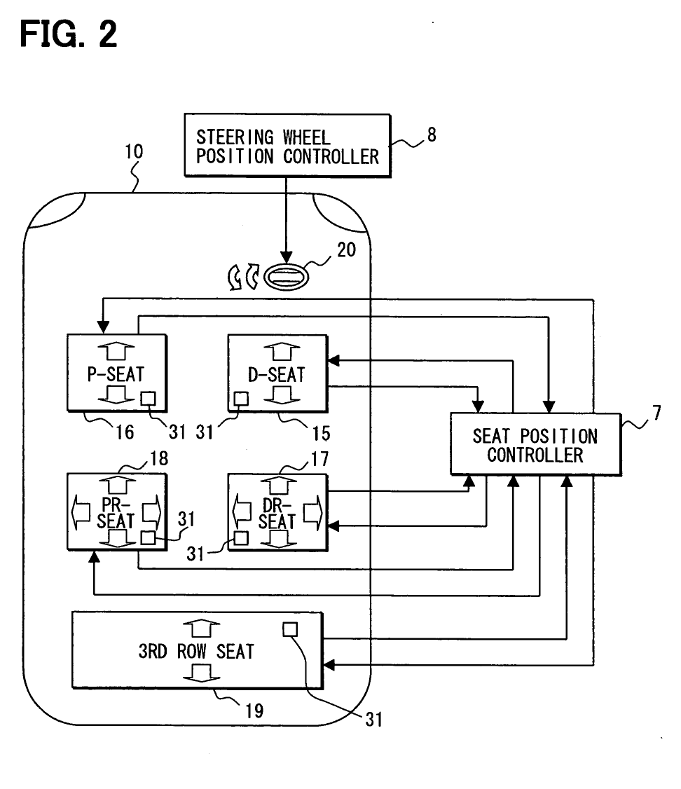

The vehicle unit 30 also has a seat position controller 7 for controlling the seat position, and a steering position controller 8 for controlling the steering wheel position. Referring to FIG. 2, the vehicle 10 includes a driver seat (D-seat) 15 and a front passenger seat (P-seat) 16. In one embodiment, the driver seat 15 and front passenger seat 16 each move forward and rearward (via a motor, etc.) within the passenger compartment. The vehicle 10 also includes a second row of seats including a driver side second row seat 17 (DR seat) and a passenger side second row seat 18 (PR seat). In one embodiment, each second row seat 17, 18 is a so-called “captain seat” and can move forward, rearward, and to each side of the vehicle 10 via a motor, etc. Further, the vehicle 10 includes a third row seat 20. In one embodiment, the third row seat 20 is a so-called “bench seat” and can move forward and rearward via a motor, etc.

It will be appreciated that the configuration of the seats 15, 16, 17, 18, 19 is merely one embodiment, and the present invention is not limited to the above configuration. For example, there could be any number of seats within the vehicle 10 and disposed in any suitable position. Also, the seats 15, 16, 17, 18, 19 could move in any direction and in any suitable fashion. For example, in one embodiment, the D-seat 15 and/or the P-seat 16 can additionally move sideways similar to the second row seats 17, 18. Further, one or more of the second row seats 17, 18 could include a configurable seat/table device for use as a seat or a table. Further, the third row seat 19 may be divided into plural portions, and these respective portions may be moved independently in the forward and backward directions.

The seat position controller 7 receives a seat position changing signal from the controller 4 and outputs a driving signal to the motor of each seat, such that the seat moves to a position corresponding to the associated seat position changing signal. In one embodiment, the position of each seat is detected by a sensor (not shown), and the position of each seat is inputted to the seat position controller 7. The seat position controller 7 stops the movement of the seat when in a position corresponding to the seat position changing signal. In another embodiment, the position of the seat is calculated on the basis of output time of the driving signal, etc. with respect to the motor of the corresponding seat. Also, in one embodiment, the user can adjust the position of each seat to a preferable position by using an operation switch (not shown) connected to the seat position controller 7.

The vehicle unit 30 also includes a user detecting device 31 for detecting the position of the user within the vehicle 10. Generally speaking, the user detecting device 31 changes the position of one or more of the seats 15, 16, 17, 18, 19 depending on the position of the user.

In one embodiment, the user detecting device 31 comprises a plurality of infrared sensors, which are mounted to the seats 15, 16, 17, 18, 19, and the sensors can detect the presence/absence of a user's legs. The sensors of the user detecting device 31 are able to detect the position of the user relative to the vehicle 10 and the seats 15, 16, 17, 18, 19. The sensors are in communication with the controller 4 and send signals to the contoller 4 corresponding to the position of the user. The user detecting device 31 can thus detect where the user is located in the vehicle to thereby move one or more of the seats 15, 16, 17, 18, 19 and to thereby facilitate movement of the user within the vehicle 10 (e.g., to facilitate moving between and/or around the seats 15, 16, 17, 18, 19). More specifically, the user detecting device 31 can move one or more of the seats 15, 16, 17, 18, 19 to allow the user to bypass (i.e., move around) one or more of the seats 15, 16, 17, 18, 19. Also, in one embodiment, the user detecting device 31 can detect that the user has bypassed (i.e., moved around) the seat 15, 16, 17, 18, 19, and the seat position controller 7 causes the seat 15, 16, 17, 18, 19 to return to its original position.

Also, in one embodiment, the user detecting device 31 can detect when a user is seated in a particular seat 15, 16, 17, 18, 19. For example, the user detecting device 31 comprises a load sensor mounted to one or more of the seats 15, 16, 17, 18, 19, and the load sensor detects the load applied by the user when sitting in the seat 15, 16, 17, 18, 19.

It will be appreciated that the user detecting device 31 can include a single type of sensor for detecting the position of the user as well as whether the user is sitting in a particular seat. For instance, in the infrared sensor embodiment described above, the infrared sensor may detect that the user's legs have moved in front of a seat 15, 16, 17, 18, 19, and if the infrared sensor detects that the user's legs have not moved from in front of the seat 15, 16, 17, 18, 19 it is detected that the user is sitting within that seat 15, 16, 17, 18, 19.

It will also be appreciated that the user detecting device 31 could include any suitable type of sensor in addition to, or in place of, the infrared sensors and load sensors described above. For instance, the user detecting device 31 could detect the position of the user via light transmission, sound wave transmission, radio wave transmission (e.g., ultrasonic, milli-waves), etc.

The steering wheel position controller 8 is in communication with the controller 4 and receives a steering position changing signal therefrom. As a result, the steering position controller 8 outputs a driving signal to a steering wheel motor so as to move the steering wheel 20 according to the steering position changing signal. In one embodiment, the steering wheel motor is able to move the steering wheel 20 upward and downward. In one embodiment, the steering wheel 20 moves upward and downward solely by tilting movement. In another embodiment, the steering wheel 20 tilts in addition to upward and downward movement.

The position of the steering wheel 20 is detected by a sensor (not shown), the position of the steering wheel 20 is inputted to the steering wheel position controller 8. Thus, the steering wheel position controller 8 can move the steering wheel 20 to a position corresponding to the steering position changing signal. In one embodiment, the position of the steering wheel 20 can also be manually adjusted to a preferable position by the user via an adjusting switch (not shown) in communication with the steering wheel position controller 8.

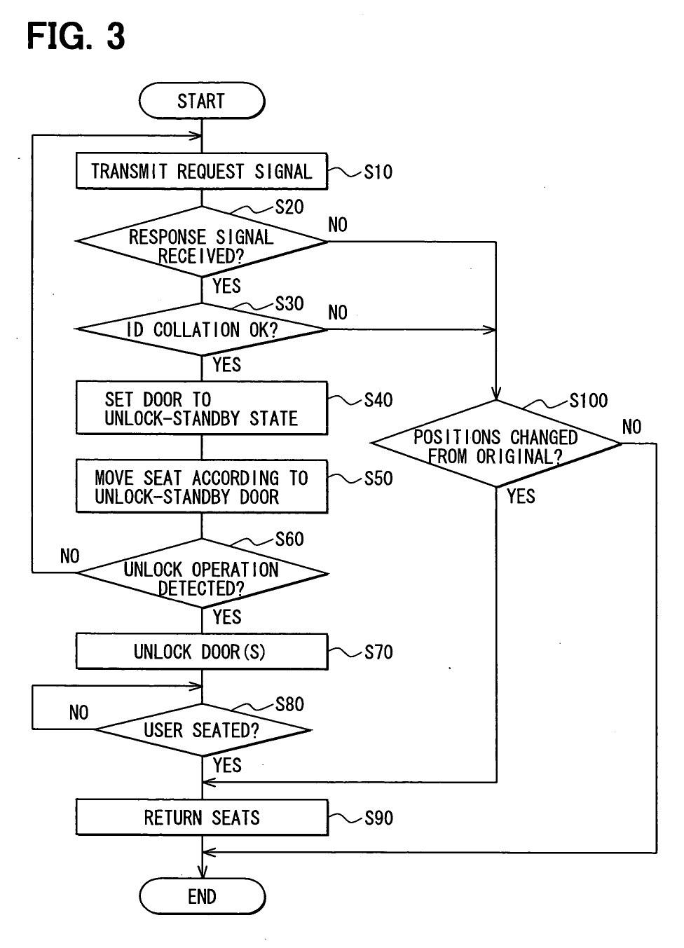

Next, control for unlocking the respective doors 11-14 and changing the seat and steering wheel position based on the collating result will be explained in detail in connection with FIG. 3. The process represented in FIG. 3 is executed at a predetermined time. In one embodiment, for instance, the process begins when the engine of the vehicle 10 is stopped, the vehicle is parked, and the doors 11-14 are locked (i.e., are in a locked state).

First, in step S10, a transmission instruction signal is output to the exterior transmitters 2a-2d, and a request signal is transmitted from the exterior transmitters 2a-2d. Then, in step S20, it is determined whether a response signal from the portable device 1 has been received. When no response signal is received, it is determined that the portable device 1 is outside of the communication range of each exterior transmitter 2a-2d (i.e., the portable device 1 is unable to communicate with any exterior transmitter 2a-2d), and step S100 follows. In contrast, when the response signal is received from the portable device 1, step S30 follows.

Specifically, the request signal (including the predetermined identification code of the exterior transmitters 2a-2d) is transmitted from the exterior transmitters 2a-2d. If the portable device 1 is within communication range, the portable device 1 returns the response signal (including the identification code). Otherwise, the controller 4 gives instructions for sequentially transmitting the request signal from the respective transmitters 2a-2d. Thus, the controller 4 can detect whether the portable device 1 returns the response signal in response to the request signal, and the controller 4 can determine whether the user is approaching one of the vehicle doors 11-14 with the portable device 1.

Thus, in step S30, it is judged whether the ID code included in the response signal satisfies a predetermined relation or not, such as whether this ID code conforms to a predetermined ID code, etc. The collating result is OK when the ID code conforms to the predetermined ID code, etc., and the collating result is NO when the ID code does not conform to the predetermined ID code, etc. When the collating result is determined as OK in step S30, step S40 follows. In contrast, when the collating result of the ID code is determined as NO, step S100 follows.

In step S40, one or more of the doors 11-14 are set to an unlock-standby state. The controller 4 outputs an unlock signal to thereby set one or more of the vehicle doors 11-14 to an unlock standby state. In one embodiment, a vehicle door 11-14 is set to the unlock standby state by energizing the respective touch sensor 6a1-6d1. In one embodiment, only the door(s) 11-14 with the exterior transmitter(s) 2a-2d that communicated with the portable device 1 is/are set to an unlock-standby state. In one embodiment, the exterior transmitter(s) 2a-2d that communicated with the portable device 1 is/are identified from the identification code included in the response signal. In another embodiment, the exterior transmitter(s) 2a-2d that communicated with the portable device 1 is/are identified from the reception timing of the response signal.

Then, in step S50, the seat position and/or the steering wheel position are changed according to the door(s) set to the unlock-standby state. In one embodiment, only the seat(s) and/or the steering wheel adjacent the door(s) set to unlock-standby state are moved. It will be appreciated that the door(s) set to the unlock-standby state is/are likely to be opened by the user because the user is adjacent that/those door(s). Once the door(s) is/are opened, step S50 ensures that the seats 15-19 facilitate access into the vehicle 10 and about the seats 15-19.

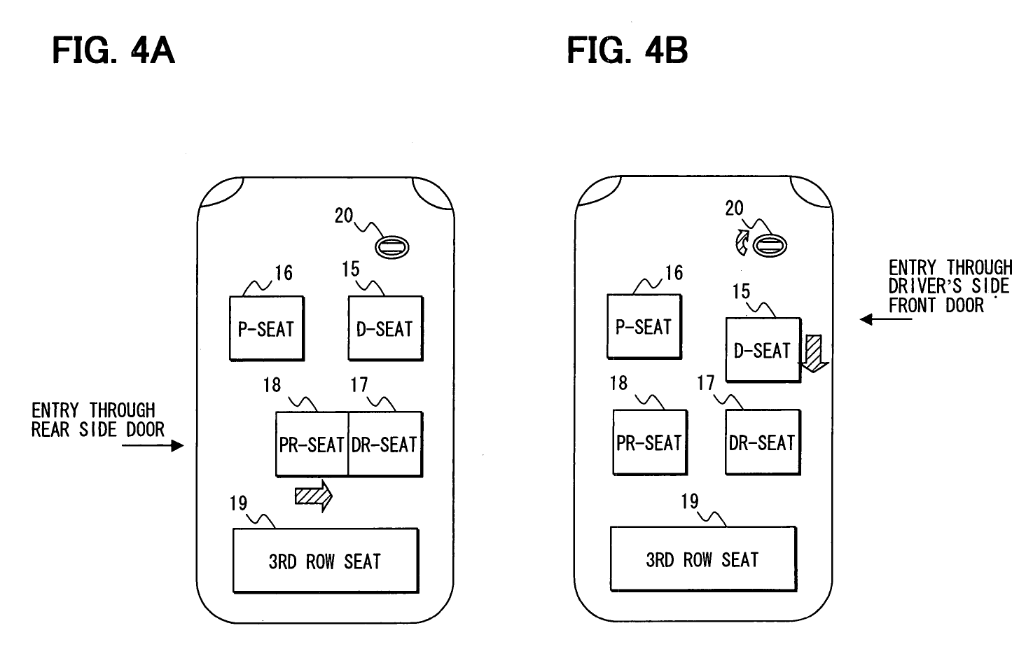

Here, the changes of the seat position and the steering wheel position will be explained in reference to FIGS. 4A and 4B. For example, when the holder of the portable device 1 is approaching the passenger side rear door as shown in FIG. 4A, the passenger side second row seat 18 (i.e., the seat adjacent the passenger side rear door) is moved sideways away from the passenger side rear door. The movement of the seat 18 occurs so as to create space between the seat 18 and the passenger side rear door, and to allow the user to move more easily into the vehicle 10 and about the seat 18 to the first row seats 15, 16, the third row seat 19, or any desired position within the vehicle 10. When the user enters the vehicle 10 from the driver's side rear door, the driver's side second row seat 17 is moved in a direction opposite to the movement shown in FIG. 4A (i.e., the seat 17 moves sideways away from the driver's side rear door).

Further, when the user approaches the driver side front door (FIG. 4B), the driver's seat 15 is moved rearward and the steering wheel 20 is moved upward. Thus, space in front of the driver's seat 15 is enlarged by moving the driver's seat 15 and the steering wheel to thereby allow the user to more easily enter the vehicle and to more easily site in the driver's seat 15 from the driver side door. Further, when the user opens the passenger side front door, the passenger seat 16 is moved rearward to facilitate entry into the vehicle 10 and into the passenger seat 16.

Next, in step S60, it is determined whether an unlock operation has been detected for any of the doors 11-14 set to the unlock-standby state in step S40. As mentioned above, the door(s) 11-14 approached by the user are changed to an unlock-standby state, and the touch sensor(s) 6a1-6d1 within the respective door handle(s) 6a-6d is/are energized. Thus, it is possible in step S60 to detect if the user grips the respective door handle(s) 6a-6d.

When no unlock operation is detected in step S60, the process waits until the unlock operation is detected. However, in the embodiment shown, when no unlock operation is detected for a predetermined time, the process returns to step S10.

When it is judged in step S60 that the unlock operation is detected, step S70 follows, and the respective door(s) 11-14 is/are unlocked. In one embodiment, only one door is unlocked (i.e., the door 11-14 gripped by the user with the portable device 1). In another embodiment, each door 11-14 is unlocked when the user with the portable device 1 grips one of the door handles 6a-6d. Thus, the user with the portable device 1 can automatically unlock and open the door(s) 11-14. When the user enters the vehicle 10, the position of the seat(s) 15-19 and/or the steering wheel 20 has been adjusted to facilitate entry into the vehicle 10 and movement about the seat(s) 15-19 and/or steering wheel 20. Furthermore, in this embodiment, the position of the seats 15-19 and/or the steering wheel 20 is changed when the collating result of the ID code is “OK,” (i.e., before the user opens the door(s) 11-14 and before the user enters the vehicle 10). Therefore, the seats 15-19 and the steering wheel 20 are properly positioned well before the user opens the door(s) 11-14 and enters the vehicle 10 for added convenience.

In some cases, a user without the portable device 1 may open a door 11-14. In such a case, the opening of the door 11-14 can be detected via a door courtesy lamp circuit being switched on, or in another suitable manner. As a result, the position of the seat(s) 15-19 and/or the steering wheel adjacent the opened doors 11-14 can be changed to facilitate movement of the user into and through the vehicle 10. For instance, if a user without the portable device 1 opens either or both of the left and right rear slide doors 12, 14, either one or both of the second row seats 17,18 can be moved sideways towards the center of the vehicle 10.

Next, in step S80, it is determined whether or not the user has been seated. In one embodiment, the user detecting device 31 (e.g., the sensors mounted to the seats 15-19) detect whether the user has been seated in step S80. In one embodiment, an affirmative determination is made in step S80 when it is also determined that all the vehicle doors 11-14 are closed (e.g., via the courtesy lamp circuits, etc.). Also, in one embodiment, an affirmative determination is made in step S80 when it is also determined that the engine has been started.

If it is determined that the user has not been seated, step S80 is repeated. If it is determined that the user has been seated, step S90 follows and the respective seat(s) and/or steering wheel 20 is/are automatically returned to an original position stored in memory. In other words, the seat position controller 7 and the steering position controller 8 output a signal for returning the seat(s) and/or the steering wheel 20 to an original position. The original position of the seat(s) 15-19 and/or steering wheel 20 is saved in memory. As such, the position of the seat(s) 15-19 and/or steering wheel 20 can be automatically returned to a comfortable position for the convenience of the user.

Furthermore, as shown in FIG. 3, step S100 is executed when either a response signal is not received in step S20 or when the ID collation result is “NO” in step S30. In step S100, it is determined whether the position of the seat(s) 15-19 and/or the steering wheel 20 has been changed from the original position(s). In other words, it is determined whether the seat(s) 15-19 and/or the steering wheel 20 have been moved as described above to facilitate entry and movement in the vehicle 10. When an affirmative determination is made in step S100, step S90 follows, and the seat(s) 15-19 and/or the steering wheel 20 is/are returned to the original position. When a negative determination is made in step S100, the process terminates.

In one embodiment, it can be determined whether the user with the portable device 1 has moved away from the vehicle 10. Thus, in step S20, the response signal is not received, or in step S30, the collation result is not “OK,” As a result, step S100 is executed.

Thus, in accordance with the embodiment described above, the position of the seat 15-19 and/or the steering wheel 20 adjacent the door to be entered by the user is changed. Accordingly, the user is able to more easily enter and move through the vehicle 10 because movement of the user is less likely to be inhibited by the seats 15-19 and/or the steering wheel 20.

### Second Embodiment

Next, a vehicle control system in accordance with a second embodiment of the present invention will be explained. The vehicle control system in this embodiment is constructed similarly to the vehicle control system of the first embodiment described above, and an explanation relating to this construction is therefore omitted.

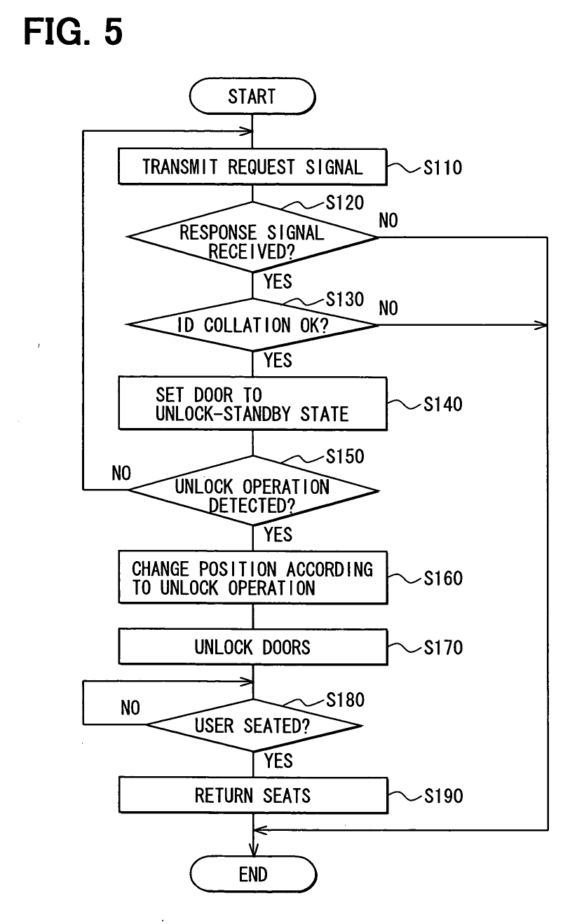

When the user with the portable device 1 grips one of the door handles 6a-6e, it is reasonable to assume that the user will open the corresponding door 11-14 and enter the vehicle 10. Accordingly, the position change of the seat 15-19 and/or steering wheel 20 is triggered by an unlock instruction operation with respect to the door handle 6a-6d. The control process of this embodiment is illustrated in the flow chart of FIG. 5. Steps S110 through S140 are the same as steps S10 through S40, respectively, shown in FIG. 3 and described above, and descriptions thereof are therefore omitted.

In step S150, it is determined whether an unlock operation has been detected. If one or more of the door handles 6a-6d are not touched within a predetermined amount of time, a negative determination is made, and the process returns to step S110. If the user with the portable device 1 contacts one or more of the door handles 6a-6d, an affirmative determination is made, and step S160 follows.

In step S160, a seat position changing signal and a steering wheel position changing signal are outputted to the seat position controller 7 and the steering wheel position controller 8, and the seat position and the steering position are changed in the manner described above. The process continues with steps S170-S190, which are substantially the same, respectively, as steps S70-S90 of FIG. 3.

Thus, in accordance with this embodiment, when it is judged by such processings that the collating result of the ID code is OK and the unlock operation is detected, the position of the seat(s) 15-19 and/or steering wheel 20 is changed approximately simultaneously.

### Third Embodiment

A vehicle control system in accordance with a third embodiment of the present invention will now be explained. The vehicle control system 30 in this embodiment is constructed similarly to the vehicle control system 30 of the above first embodiment. Thus, an explanation relating to its construction is omitted.

In the vehicle control systems in the above first and second embodiments, the seat position and the steering position are returned to a predetermined position in steps S90 and S190, respectively. More specifically, the seat(s) 15-19 and steering wheel 20 are returned to an initial, or original position. However, the user may still desire further movement of the seat 15-19 and/or steering wheel. Thus, in the third embodiment, the user-adjusted position(s) of the seats(s) 15-19 and/or the steering wheel 20 are stored in memory such that the vehicle unit 30 can return the seat(s) 15-19 and/or steering wheel 20 to that/those position(s).

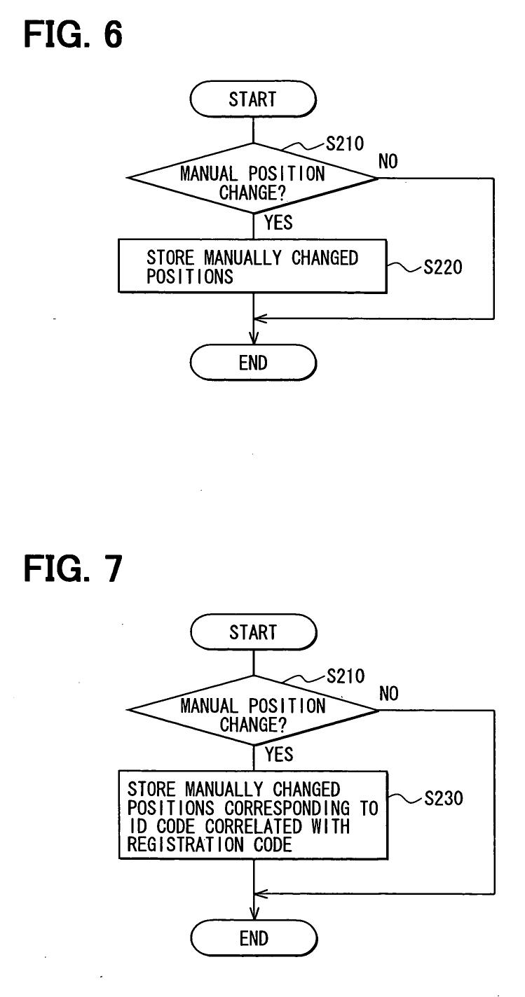

More specifically, as shown in the flow chart of FIG. 6, the vehicle unit 30 returns the seat(s) 15-19 and/or the steering wheel 20 to a “predetermined position,” namely the position set by the user. Specifically, in step S210 of FIG. 6, it is determined whether the seat position and/or steering wheel position has been changed manually by the user using, for example, a switch. When an affirmative determination is made in step S210, the procedure proceeds to step S220, and the position(s) manually set by the user is/are stored as the “predetermined position(s)” to which the vehicle unit 30 returns the seat(s) 15-19 and/or the steering wheel 20 in steps S90 (FIG. 3) and S190 (FIG. 5).

In one embodiment, a plurality of portable devices 1 are set to communicate with one vehicle unit 30, and each portable device 1 is constructed so as to perform the unlock of the doors 11 to 14, etc., as described above. In this embodiment, the controller 4 is constructed such that plural registration codes are registered and correspond to the ID codes of the portable devices 1, and collation can be performed in the ID code of any of the portable devices 1. In such a case, as shown by step S230 of the flow chart of FIG. 7, the manually changed positions are stored as the “predetermined position(s)” corresponding to the ID code collated with the registration code. As such, the positions of the seats 15-19 and/or steering wheel 20 can be returned to a position according to a particular user (i.e., a particular portable device 1).

### Fourth Embodiment

A vehicle control system in accordance with a fourth embodiment of the present invention will next be explained. The vehicle control system in this embodiment is constructed similarly to the vehicle control system of the above first embodiment, and an explanation relating to its construction is therefore omitted.

In this embodiment, a plurality of registration codes are registered to the controller 4 corresponding to the ID codes of a plurality of plural portable devices 1. Thus, collation can be performed in the ID code of any of the portable devices 1. There is a possibility that the group of users with particular portable devices 1 will occupy the same seats 15-19 in the vehicle 10. Therefore, as will be explained, a seat position is calculated for one or more seat(s) 15-19, and the vehicle unit 30 changes the position of the seat(s) 15-19 according to the calculation for added convenience.

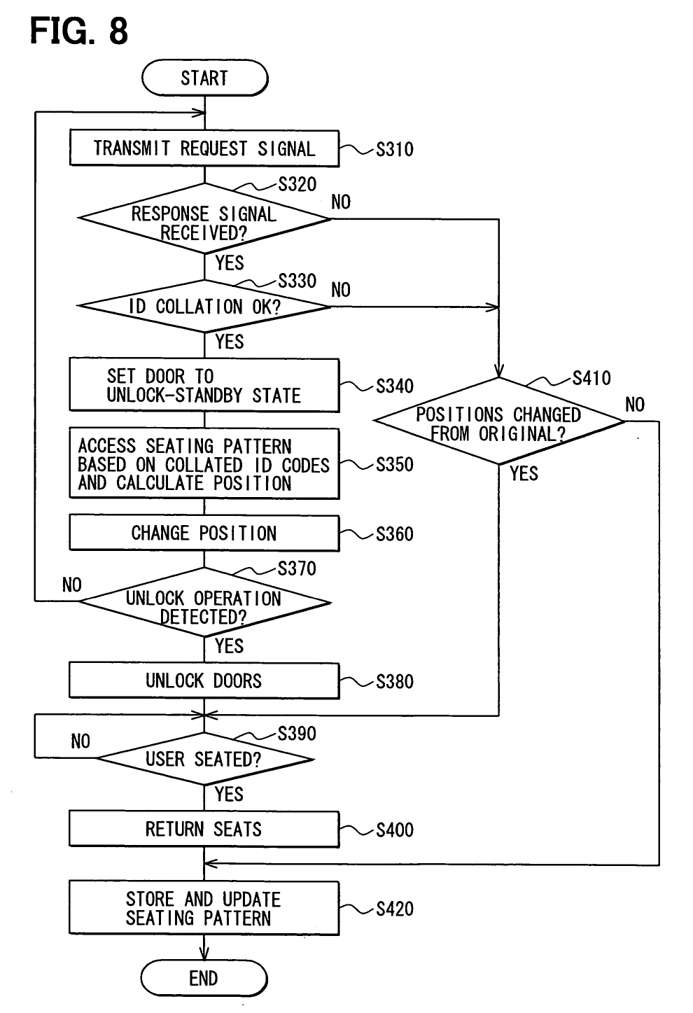

This process is explained in relation to the flow chart of FIG. 8. Steps S310-S340 are the same as steps S10-S40 of the flow chart of FIG. 3, respectively. Also, steps S370-S410 are the same as steps S60-S100 of the flow chart of FIG. 3, respectively. Therefore, steps S310-S340 and steps S370-S410 are not explained further.

Thus, after steps S310-S340 and after the collating of the ID codes is completed, step S350 occurs, and a predetermined seating pattern is accessed, which correlates to the collated ID codes. More specifically, the seating pattern identifies which seat will likely be occupied according to the ID codes collated in step S330. Then, a changing position for each seat (including the seat adjacent the door that will likely be opened) is calculated on the basis of the seating pattern.

Then, in step S360, a seat position changing signal is outputted to the seat position controller 7 in accordance with the changing position calculated in step S350, and the seat position is thereby changed to the calculated changing position. In one embodiment, step 360 further involves changing the position of the steering wheel 20.

For example, where the seating pattern for the collated ID codes identifies that the users are likely to sit in the second row seats 17, 18 and not the third row seat 19, the second row seats 17, 18 are each moved rearward instead of toward the center of the vehicle 10. Thus, the users can more easily enter the vehicle 10 and move toward the second row seats 17, 18.

Further, when the seating pattern identifies that the users are likely to sit in the second row and third row seats 17, 18, 19, the second row seats 17, 18 are moved in the width direction toward the center of the vehicle 10, and the third row seat 19 is moved rearward. Accordingly, it is easier to move into the vehicle and into the second and third row seats 17, 18, 19.

In step S420, after the users have been seated, the seating pattern identifying the occupied and unoccupied seats is stored in relation to the ID code collated in step S330. When there is already a seating pattern stored with respect to the collated ID code, the stored seating pattern is updated to the newly detected seating pattern. Thus, entering and moving within the vehicle 10 can be achieved more easily each time a particular combination of users approaches the vehicle 10.

### Fifth Embodiment

Next, a vehicle control system in accordance with a fifth embodiment of the present invention will be explained. The vehicle control system in this embodiment is constructed similarly to the vehicle control system of the above first embodiment. Thus, an explanation relating to this construction is therefore omitted.

In the vehicle control system of this embodiment, when the users enter the vehicle 10 through the opened doors 11 to 14 and move between the seats 15-19, the movements of the users within the vehicle 10 are detected so as to automatically move the seats 15-19 and/or the steering wheel 20. As such, the users can more easily move within the vehicle 10.

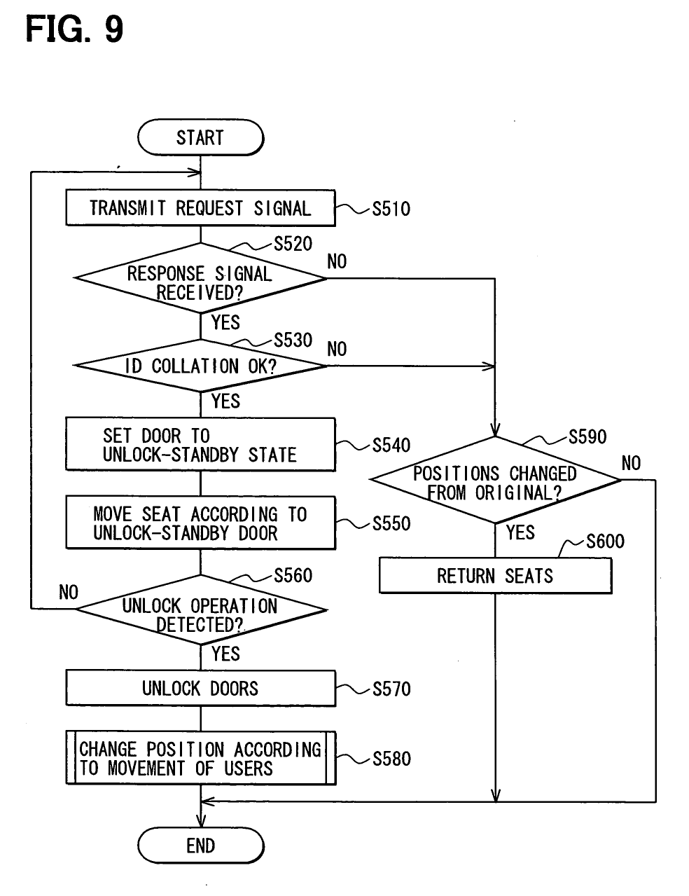

The fifth embodiment is illustrated in the flow chart of FIG. 9. Steps S510-S570 are the same as steps S10-S70 of the flow chart of FIG. 3, respectively, and the explanations thereof are therefore omitted. Furthermore, steps S590 and S600 are the same as steps S100 and S90 of the flow chart of FIG. 3, respectively, and the explanations therefore are omitted.

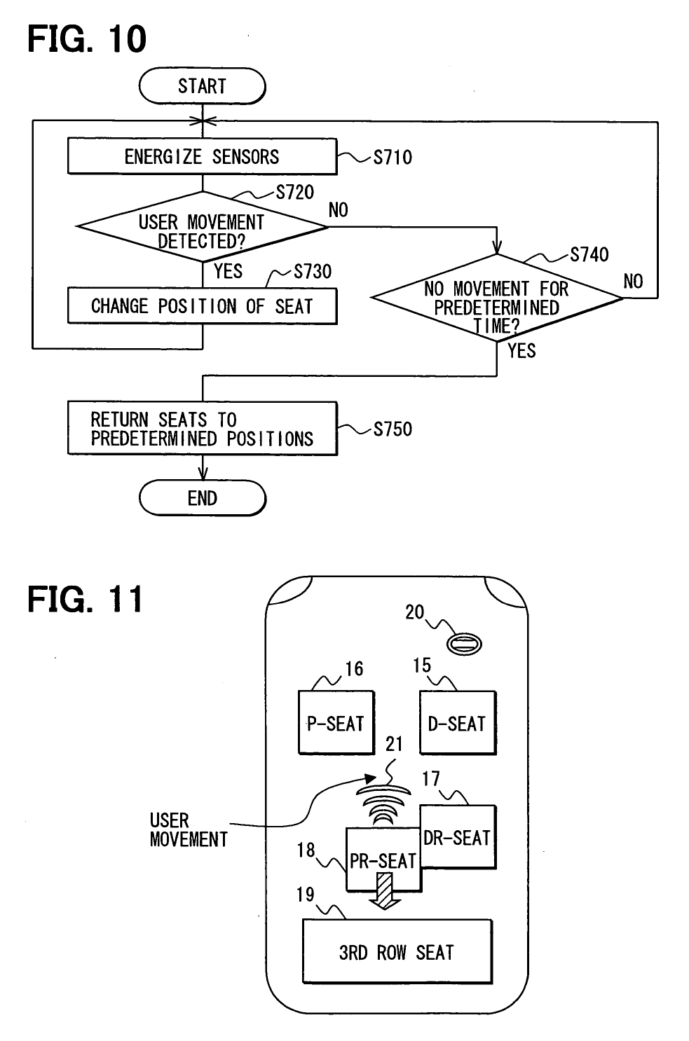

In this embodiment, when the doors 11-14 are unlocked in step S570, changing control of the seat position according to the movement of the crew member within the vehicle 10 occurs in step S580. This changing control of the seat position is shown in detail in the flow chart of FIG. 10.

First, in step S710, one or more sensors of the user detecting device 31 is energized. Then, in step S720, it is determined whether any movement of the users is detected. When movement is detected, step S730 follows, and the one or more seats 15-19 are moved according to the movement of the users. Accordingly, the users are able to more easily move about the seats 15-19 and move within the vehicle 10.

For example as shown in FIG. 11, when the user enters the vehicle 10 from the slide door 14 and moves forward of the second row seat 18, the sensor mounted to the second row seat 18 can detect such movement (i.e., in the detecting range 21). Then, the controller 4 outputs instructions to the seat position controller 7 for moving the second row seat 18 rearward so as to enlarge the space in front of the second row seat 18. Thus, the user can more easily move to the second row seat 17, the driver's seat 15 and/or the passenger seat 16. In this case, the controller 4 may additionally cause the passenger seat 16 to move forward for added space.

In this embodiment, the sensor of the user detecting device 31 is arranged so as to detect movement of the user in front of the seats 15-19. However, especially with respect to the first and second row seats 15-18, the sensors may be arranged so as to detect movement of the user between the seats. Thus, for example, as the user moves from one of the second row seats 17, 18 to one of the first row seats 15, 16, the first row seats 15, 16 can be automatically moved away from each other in the width direction to thereby create more space for the user.

When movement is not detected in step S720, it is determined in step S740 whether no movement has been detected for a predetermined amount of time. When an affirmative determination is made, it is determined that the users are already sitting. Therefore, in step S750, the seat(s) 15-19 and/or the steering wheel are returned to initial positions, and processing is terminated.

The explanation of the present invention has been made with respect to certain embodiments described above. However, the present invention is not limited to the above embodiments, but can be variously modified and executed without departing from the scope of the present invention.

For example, in each of the above embodiments, the door 11-14 approached by the user with the portable device 1 is distinguished from the other doors 11-14 on the basis of the mutual communication of the vehicle unit 30 and the portable device 1, and the door 11-14 intended to be opened is specified by the unlock operation with respect to the door handles 6a-6d. However, the vehicle control system may also be constructed to identify the “door to be opened” based on actual movement of the door (e.g., based on the courtesy lamp circuit, etc.). Thus, once the user begins to move the door toward the open position, the vehicle control system identifies that door at the door that is to be opened, and the vehicle control system changes the seat position and/or the steering wheel position.

What is claimed is:

1. A vehicle control system for a vehicle comprising:
a door opening detecting device for identifying a door of the vehicle to be opened; and
a position changing device for changing the position of at least one seat based upon the identification of the door to be opened.

2. The vehicle control system according to claim 1, wherein the vehicle control system further comprises a user detecting device for detecting the position of the user within the vehicle, and
wherein the position changing device changes the position of the at least one seat depending on the position of the user.

3. The vehicle control system according to claim 2, wherein the user detecting device is mounted to the at least one seat.

4. The vehicle control system according to claim 2, wherein the user detecting device detects the position of the user via at least one of a light transmission, a sound wave transmission, and radio wave transmission.

5. The vehicle control system according to claim 2, wherein the position changing device moves the at least one seat away from a predetermined position to thereby allow a user to bypass the at least one seat, and wherein the position changing device returns the at least one seat to the predetermined position once the user detection device detects that the user has bypassed the at least one seat.

6. The vehicle control system according to claim 2, wherein the position changing device stores a user-defined predetermined position of the seat in memory, and wherein the position changing device returns the seat to the user-determined predetermined position when the user detecting device detects that the user is seated.

7. The vehicle control system according to claim 1, wherein the vehicle comprises at least one first row seat, at least one second row seat, and at least one third row seat, and wherein the vehicle comprises at least one side door adjacent the at least one second row seat, and
wherein the position changing device changes the position of the at least one second row seat by moving the at least one second row seat away from the at least one side door when the at least one side door is identified as the door to be opened.

8. The vehicle control system according to claim 1, wherein the vehicle defines a rearward direction and an upward direction,
wherein the vehicle comprises a driver's seat, a steering wheel, and a driver's side door adjacent the driver's seat and the steering wheel, and
wherein the position changing device moves the driver's seat in the rearward direction and the steering wheel in the upward direction when the driver's side door is identified as the door to be opened.

9. The vehicle control system according to claim 8, further comprising a user detection device for detecting when a user is seated in the driver's seat, and
wherein the position changing device returns the driver's seat and the steering wheel to respective predetermined positions when it is detected by the user detection device that the user is seated in the driver's seat.

10. The vehicle control system according to claim 9, wherein the respective predetermined positions of the driver's seat and the steering wheel are predetermined by the user and are stored in memory.

11. The vehicle control system according to claim 1, wherein the position changing device is operable for returning the at least one seat to a predetermined position.

12. The vehicle control system according to claim 11, wherein the predetermined position is determined by a user.

13. A vehicle control system for a vehicle comprising:
a portable device; and
a vehicle unit comprising:
a plurality of transmitters for transmitting a request signal, and wherein the portable device is able to transmit a response signal that includes an ID code in response to the request signal;
a receiver for receiving the response signal that includes the ID code;
a controller that collates the ID code and a predetermined registration code to thereby generate a collating result, and wherein the collating result is OK when the ID code conforms to the predetermined registration code;
a door opening detection device for identifying a door of the vehicle to be opened when the collating result is OK; and
a position changing device for changing the position of at least one seat based upon the identification of the door to be opened.

14. The vehicle control system according to claim 13, wherein the vehicle unit further comprises a door lock device for unlocking the door to be opened;
wherein the controller outputs an unlock signal to the door lock device when the collating result is OK; and
wherein the controller outputs a changing instruction to the position changing device to thereby change the position of the at least one seat based upon the unlock signal.

15. The vehicle control system according to claim 14, wherein the door lock device comprises a touch sensor, and wherein the controller outputs the unlock signal to thereby energize the touch sensor to thereby change the door lock device to an unlock standby state, and wherein the door lock device unlocks the door when a user touches the touch sensor.

16. The vehicle control system according to claim 13, further comprising a plurality of portable devices,
wherein the vehicle unit can generate a collating result for each of the portable devices and can determine a seating pattern in the vehicle according to the collating result of each portable device, and
wherein the position changing device changes the position of the at least one seat according to the seating pattern.

17. The vehicle control system according to claim 13, wherein the vehicle unit further comprises a user detecting device for detecting the position of the user within the vehicle, and
wherein the position changing device changes the position of the at least one seat depending on the position of the user.

18. The vehicle control system according to claim 17, wherein the user detecting device is mounted to the at least one seat, and wherein the user detecting device detects the position of the user via at least one of a light transmission, a sound wave transmission, and radio wave transmission.

19. The vehicle control system according to claim 13, wherein the vehicle comprises at least one first row seat, at least one second row seat, and at least one third row seat, and wherein the vehicle comprises at least one side door adjacent the at least one second row seat, and
wherein the position changing device changes the position of the at least one second row seat by moving the at least one second row seat away from the at least one side door when the at least one side door is identified as the door to be opened.

20. The vehicle control system according to claim 17, wherein the position changing device moves the at least one seat away from a predetermined position to thereby allow a user to bypass the at least one seat, and wherein the position changing device returns the at least one seat to the predetermined position once the user detection device detects that the user has bypassed the at least one seat.

21. The vehicle control system according to claim 17, wherein the position changing device stores a user-defined predetermined position of the seat in memory, and wherein the position changing device returns the seat to the user-determined predetermined position when the user detecting device detects that the user is seated.

22. The vehicle control system according to claim 17, wherein the position changing device is operable for returning the at least one seat to a predetermined position depending on the position of the user, and wherein the predetermined position is determined by a user.

23. The vehicle control system according to claim 13, wherein the vehicle defines a rearward direction and an upward direction,
wherein the vehicle comprises a driver's seat, a steering wheel, and a driver's side door adjacent the driver's seat and the steering wheel, and
wherein the position changing device moves the driver's seat in the rearward direction and the steering wheel in the upward direction when the driver's side door is identified as the door to be opened.

24. The vehicle control system according to claim 23, further comprising a user detection device for detecting when a user is seated in the driver's seat, and
wherein the position changing device returns the driver's seat and the steering wheel to respective predetermined positions when it is detected by the user detection device that the user is seated in the driver's seat.

25. The vehicle control system according to claim 24, wherein the respective predetermined positions of the driver's seat and the steering wheel are predetermined by the user and are stored in memory.

26. The vehicle control system according to claim 13, further comprising a plurality of portable devices,
wherein the vehicle unit can generate a collating result for each of the portable devices, and
wherein the position changing device is operable for returning a plurality of seats to a user-determined predetermined position according to the collating results.
